(19) United States
(12) Patent Application Publication
(10) Pub. No.: US 2019/0114838 A1
(43) Pub. Date: Apr. 18, 2019

(54) AUGMENTED REALITY SYSTEM AND METHOD FOR PROVIDING AUGMENTED REALITY

(71) Applicant: ASUSTeK COMPUTER INC., Taipei (TW)

(72) Inventors: Xian ZHONG, TAIPEI (TW); Wen-Chang HUNG, TAIPEI (TW)

(21) Appl. No.: 16/150,371

(22) Filed: Oct. 3, 2018

(30) Foreign Application Priority Data
Oct. 12, 2017 (TW) 106134964

(51) Int. Cl. G06T 19/00; G02B 27/01; G06K 9/00

(52) U.S. Cl. CPC G06T 19/006; G06K 9/00671; G02B 27/017

(57) ABSTRACT

This application discloses an augmented reality system and a method for providing augmented reality. The augmented reality system includes a wearable apparatus and an electronic apparatus. The wearable apparatus has an optical lens and a connection unit. The electronic apparatus is disposed on the wearable apparatus by the connection unit, and is configured to: detect space information and display augmented reality scene information based on the space information, and project an optical signal corresponding to the augmented reality scene information to the optical lens, where the optical signal is transmitted to a plane along a first optical path by the optical lens, the augmented reality scene information includes a virtual object, the virtual object is disposed at a space coordinate in the augmented reality scene information, and the space coordinate is corresponding to a physical location in the space information.

### CROSS-REFERENCE TO RELATED APPLICATION

This application claims the priority benefit of Taiwan application serial No. 106134964, filed on Oct. 12, 2017. The entirety of the above-mentioned patent application is hereby incorporated by reference herein and made a part of the specification.

### BACKGROUND OF THE INVENTION

### Field of the Invention

This application relates to a computer system and a method for applying a computer system and, more particularly, to an augmented reality system and a method for providing augmented reality.

### Description of the Related Art

Generally, an augmented reality technology cannot provide great augmented reality by obtaining depth information. If the depth information is required for using and sensing, a user needs to hold a screen by using a hand to watch the screen. In this case, great user experience cannot be achieved. In addition, generally, the augmented reality technology needs to be directly connected to a computer host and faces restriction of moving space caused by physical lines.

### BRIEF SUMMARY OF THE INVENTION

According to first aspect, an augmented reality system is provided herein. The augmented reality system includes a wearable apparatus and an electronic apparatus. The wearable apparatus has an optical lens and a connection unit. The electronic apparatus is disposed on the wearable apparatus by using the connection unit, and is configured to: detect space information and generate augmented reality scene information according to the space information, and project an optical signal corresponding to the augmented reality scene information to the optical lens, where the optical signal is guided to a plane along a first optical path by using the optical lens, the augmented reality scene information includes at least one virtual object, the virtual object is disposed at a space coordinate in the augmented reality scene information, and the space coordinate is corresponding to a physical location in the space information.

According to second aspect, a method for providing augmented reality is provided herein. The method includes the following steps: detecting space information by using an electronic apparatus; generating, based on the space information, augmented reality scene information by using the electronic apparatus; and projecting a first optical signal corresponding to the augmented reality scene information to an optical lens by using the electronic apparatus, where the optical signal is guided to a plane along a first optical path by using the optical lens, the augmented reality scene information includes at least one virtual object, the virtual object is disposed at a space coordinate in the augmented reality scene information, and the space coordinate is corresponding to a physical location in the space information.

Therefore, the augmented reality system in this application can correct augmented reality scene information according to a relative distance and a relative angle between an optical detector and human eyes. In addition, only a virtual object is displayed to create augmented reality from a first-person viewing angle.

### BRIEF DESCRIPTION OF THE DRAWINGS

FIG. 1 is a schematic diagram of an augmented reality system according to some embodiments of this application;

FIG. 2 is a schematic diagram of an augmented reality system according to some embodiments of this application;

FIG. 3 is a schematic diagram of an augmented reality system according to some embodiments of this application;

FIG. 4 is a schematic diagram of an augmented reality system according to some embodiments of this application;

FIG. 5 is a schematic diagram of an augmented reality system according to some embodiments of this application;

FIG. 6 is a schematic diagram of an augmented reality system according to some embodiments of this application;

FIG. 7 is a schematic diagram of an augmented reality system according to some embodiments of this application; and

FIG. 8 is a flowchart of steps of an augmented reality method according to some embodiments of this application.

### DETAILED DESCRIPTION OF THE EMBODIMENTS

The terms “first”, “second”, and the like as used herein are used for distinguishing between similar elements or operations and not necessarily for describing a sequence, either temporally, spatially, in ranking or in any other manner.

As used herein, “coupled” or “connected” may mean that two or more elements or apparatuses are in direct or indirect physical contact with each other, or that two or more elements or apparatuses co-operate or interact with each other.

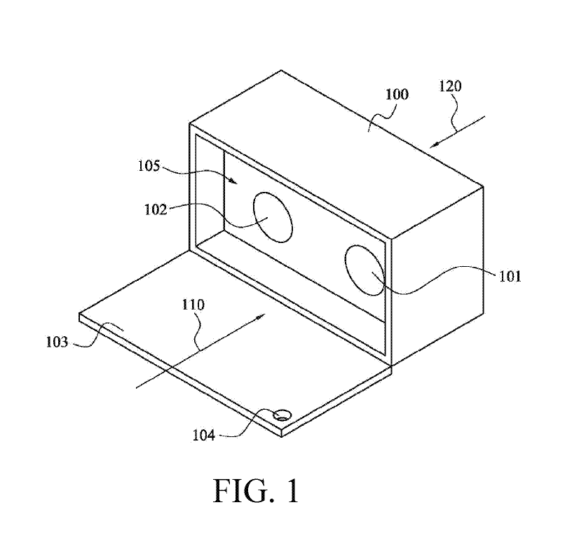

Referring to FIG. 1, FIG. 1 is a schematic diagram of an augmented reality system according to some embodiments of this application. In an embodiment of this application, the augmented reality system includes a wearable apparatus 100. The appearance of the wearable apparatus 100 is in a rectangular box shape. The wearable apparatus 100 has a first opening 110 and a second opening 120. A viewing angle shown in the figure is watching the wearable apparatus 100 from the first opening 110. The second opening 120 is formed at an end opposite to that of the first opening 110. In this embodiment, a first optical lens 101 and a second optical lens 102 are arranged in parallel inside the wearable apparatus 100, and are both disposed between the first opening 110 and the second opening 120. In an embodiment, when both the first opening 110 and the second opening 120 are in an open state, light passes through the first optical lens 101 and the second optical lens 102 to enter the second opening 120.

Still referring to FIG. 1, in an embodiment, a cover body 103 is connected with a side surface (located at a side of the first opening 110) of the wearable apparatus 100. When the cover body 103 is lifted up to cover the first opening 110, most light from the first opening 110 does not pass through the first optical lens 101 and the second optical lens 102 to enter the second opening 120. A through hole 104 is formed at a corner of the cover body 103. When the cover body 103 covers the first opening 110, light passes through the through hole 104 to enter the wearable apparatus 100. In this embodiment, when the cover body 103 covers the first opening 110, there is an accommodation space 105 between the cover body 103 and the first optical lens 101 and the second optical lens 102.

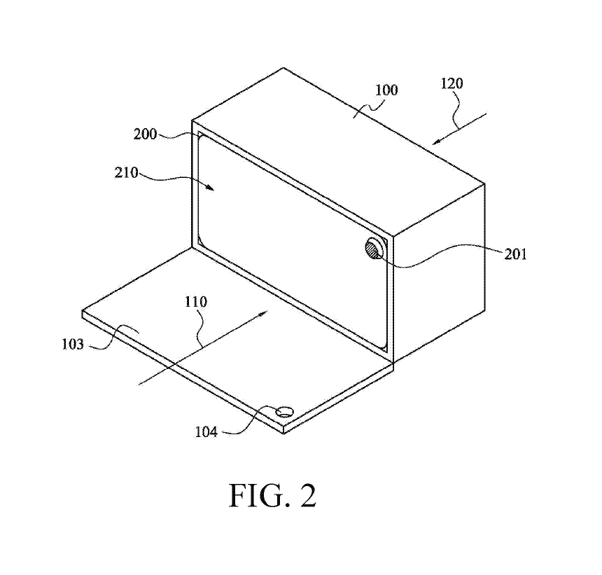

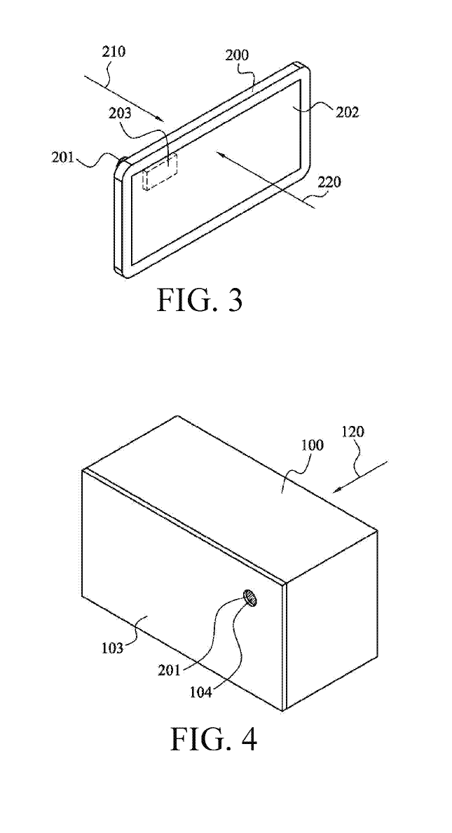

Referring to FIG. 2, FIG. 2 is a schematic diagram of an augmented reality system according to some embodiments of this application. FIG. 2 still shows the wearable apparatus 100 in FIG. 1. In this embodiment, the augmented reality system further includes an electronic apparatus 200. The electronic apparatus 200 is an independent moving apparatus. The electronic apparatus 200 includes a first side 210 and a second side 220. However, only the first side 210 of the electronic apparatus 200 is seen from a viewing angle in the figure. Configuration related to the second side 220 is shown in FIG. 3, so that FIG. 3 can be referred to together. As shown in FIG. 2, in an embodiment, the electronic apparatus 200 is built in the accommodation space 105 of the wearable apparatus 100 shown in FIG. 1, and only the first side 210 is exposed from the first opening 110 of the wearable apparatus 100. In this way, the electronic apparatus 200 is fixedly disposed on the wearable apparatus 100. In addition, one end of the first side 210 of the electronic apparatus 200 is provided with an optical detector 201. The optical detector 201 has a depth of field sensor (not shown) to detect ambient configuration in front of the first side 210 of the electronic apparatus 200 to generate space information. The space information includes information about at least one of ambient light, space configuration, a physical object, a person or depth of field in front of the first side 210 of the electronic apparatus 200.

Referring to FIG. 3, FIG. 3 is a schematic diagram of an augmented reality system according to some embodiments of this application. The electronic apparatus 200 shown in FIG. 2 is also shown in FIG. 3. The second side 220 of the electronic apparatus 200 and part of the optical detector 201 disposed on the first side 210 are seen from a viewing angle in the figure. As shown in the figure, a display screen 202 is disposed on the second side 220 of the electronic apparatus 200. A surface of the display screen 202 is configured to display a result operated by the electronic apparatus 200. As shown in the figure, a processor 203 disposed in the electronic apparatus 200 is respectively electrically coupled to the optical detector 201 and the display screen 202 (not shown in detail). Referring to FIG. 2 and FIG. 3, in an embodiment, the optical detector 201 detects the space information in front of the first side 210 of the electronic apparatus 200, and the processor 203 receives the space information obtained by the optical detector 201. The processor 203 operates augmented reality scene information according to the space information, and then displays the augmented reality scene information on the surface of the display screen 202. In this embodiment, the augmented reality scene information includes at least one virtual object. The virtual object is a three-dimensional object. At least one of size, shape, type, or aspect of the virtual object is determined by a user by touching the display screen 202 to control the processor 203.

Referring to FIG. 1 to FIG. 4, FIG. 4 is a schematic diagram of an augmented reality system according to some embodiments of application. In this embodiment, the cover body 103 covers the first opening 110 of the wearable apparatus 100. The electronic apparatus 200 is disposed in the accommodation space 105 of the wearable apparatus 100. A position of the optical detector 201 of the electronic apparatus 200 corresponds to a position at which the through hole 104 is formed, so that light enters the optical detector 201 of the electronic apparatus 200 from the through hole 104. In this embodiment, the optical detector 201 detects the space information in front of the first side 210 of the electronic apparatus 200 by the through hole 104, and transmits the space information to the processor 203 shown in FIG. 3. Because the space information includes the depth of field information, the processor 203 operates the space information by a simultaneous localization and mapping (SLAM) algorithm, so as to generate the augmented reality scene information. Then the processor 203 displays the augmented reality scene information on the surface of the display screen 202 of the second side 220.

In this embodiment, because the processor 203 processes the space information by using the SLAM algorithm, the processor 203 assigns a respective space coordinate to each location in the space information. A space coordinate is assigned to the virtual object of the augmented reality scene information, so that the virtual object is presented at the assigned space coordinate. If the virtual object represents an unmovable object, the virtual object is fixedly displayed at the assigned space coordinate. When the virtual object represents a movable object, the virtual object is able to move from the assigned space coordinate to other space coordinates. In an embodiment, the processor 203 displays a plurality of virtual objects of the augmented reality scene information. When the initial locations of the virtual objects are with a relationship, and a space coordinate is assigned to one of the virtual objects, the assigned space coordinate is defined as a reference point, the processor 203 assign space coordinates to other virtual objects according to the relationship of the initial location and the reference point.

Referring to FIG. 3 and FIG. 4, in this embodiment, the processor 203 controls the display screen 202 to display the augmented reality scene information in a stereoscope mode. The processor 203 respectively operates a stereoscope image corresponding to a left eye of a user and a stereoscope image corresponding to a right eye of a user, so that the augmented reality scene information respectively corresponding to the two eyes of the user are presented on the display screen 202 in parallel. In this embodiment, when the two eyes of the user are at a side of the second opening 120 of the wearable apparatus 100, the surface of the display screen 202 of the electronic apparatus 200 displays the augmented reality scene information, and the display screen 202 further projects an optical signal corresponding to the augmented reality scene information to a direction of the second side 220 of the electronic apparatus 200.

In other embodiments of this application, the wearable apparatus 100 does not include the cover body 103, and it uses another fixed element to prevent the electronic apparatus 200 from separating from the wearable apparatus 100 during usage.

Referring to FIG. 1 to FIG. 5, in this embodiment, when the two eyes of the user are at the side of the second opening 120 of the wearable apparatus 100, the surface of the display screen 202 of the electronic apparatus 200 displays the augmented reality scene information, and the display screen 202 further projects the optical signal corresponding to the augmented reality scene information to the direction of the second side 220 of the electronic apparatus 200. In an embodiment, interaction between the electronic apparatus 200 and the left eye LE of the user is used as an example. The display screen 202 of the electronic apparatus 200 projects the optical signal corresponding to the augmented reality scene information to the direction of the second side 220 of the electronic apparatus 200. The optical signal is transmitted along an optical path P1 from the display screen 202. The optical signal passes through the first optical lens 101 and continues to be projected along the optical path P1 to a plane to be imaged on the plane. Then, the optical signal is transmitted to an observing plane OP of the left eye LE of the user. In this embodiment, the observing plane OP is a retina of the left eye of the user. In this way, the stereoscope image of the left eye corresponding to the augmented reality scene information is imaged on the retina of the left eye of the user, so that the left eye of the user sees the stereoscope image corresponding to the left eye in the augmented reality scene information.

In this embodiment, an optical signal corresponding to the augmented reality scene information of the right eye of the user passes through the second optical lens 102 to be transmitted to the right eye of the user along an optical path. Then, the augmented reality scene information corresponding to the optical signal is displayed on a retina of the right eye of the user. When the optical signal projection by the display screen 202 passes through the first optical lens 101 and the second optical lens 102 and enters the two eyes of the user, the virtual object seems to attach to a physical object in the space information in a proper angle or direction, or the virtual object seems to interact with a physical object.

In an embodiment, the process 203 of the electronic apparatus 200 further adjust a display parameter according to a relative distance and a relative angle between the optical detector 201 and the two eyes of the user, to correct the augmented reality scene information. Therefore, when the augmented reality scene information is projected to the two eyes of the user by the first optical lens 101 and the second optical lens 102, the augmented reality scene information is displayed in a right shape and size corresponding to a real viewing angle of the user.

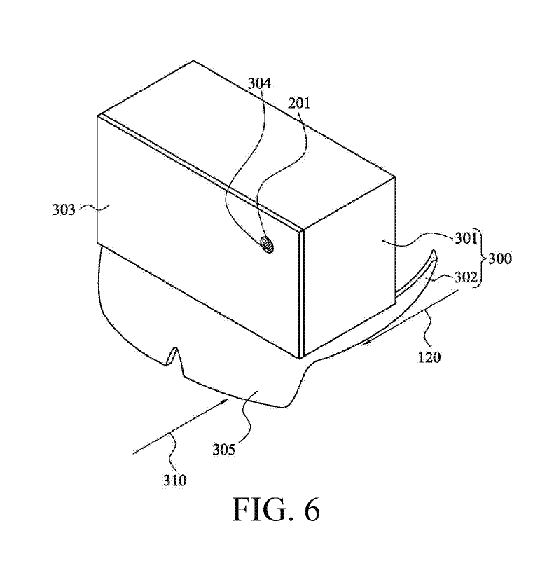

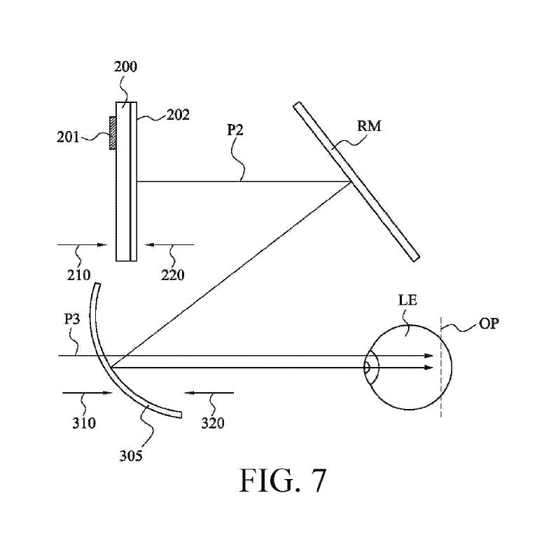

Referring to FIG. 6, FIG. 6 is a schematic diagram of an augmented reality system according to some embodiments of this application. What is shown in FIG. 6 is another implementation aspect of the augmented reality system in this application. Part of configuration of this implementation aspect is similar to the foregoing embodiments. Therefore, refer to FIG. 1 to FIG. 4 together. As shown in the figure, a wearable apparatus 300 includes an upper half part 301 and a lower half part 302. Disposing of the upper half part 301 is partially similar to the wearable apparatus 100 shown in FIG. 1, FIG. 2, and FIG. 4. In this embodiment, the upper half part 301 also includes a cover body 303. The cover body 303 is lifted up to cover a first opening (the first opening is covered by the cover body 303 in FIG. 6, the configuration of the first opening can be referred to the first opening 110 in FIG. 1 or FIG. 2 can be referred to) on one side of the upper half part 301. Same as the wearable apparatus 100 shown in FIG. 1 and FIG. 2, in this embodiment, an accommodation space (located inside the upper half part 301) is behind the cover body 303 and is configured to dispose the electronic apparatus 200 shown in FIG. 3. A through hole 304 is formed on the cover body 303, so that when the electronic apparatus 200 is disposed in the accommodation space, external light from the upper half part 301 can enter the optical detector 201 of the electronic apparatus 200 from the through hole 304. Different from the embodiments in FIG. 1 and FIG. 2, in this embodiment, no opening is disposed on the other side of the upper half part 301 of the wearable apparatus 300(that is, has no second opening 120 in FIG. 1 or FIG. 2), and no the first optical lens 101 and the second optical lens 102 is disposed inside the wearable apparatus 300.

In this embodiment, the appearance of the lower half part 302 of the wearable apparatus 300 is similar to that of glasses. A first side 310 of the lower half part 302 is provided with an optical lens 305. The optical lens 305 is disposed under and aligned with the cover body 303 of the upper half part 301. The lower half part 302 further has a second side 320 opposite to the first side 310. The second side 320 is open (not shown from a viewing angle in FIG. 6, FIG. 7 can be referred to). The lower half part 302 of the wearable apparatus 300 is worn by a user, and two eyes of the user are at the second side 320. When the two eyes of the user are at the second side 320 of the lower half part 302 of the wearable apparatus 300, an optical signal corresponding to augmented reality scene information and projected by the electronic apparatus 200 is reflected by the optical lens 305 to enter the two eyes of the user. The inner part of the wearable apparatus 300 is described below in detail.

Referring to FIG. 3, FIG. 6 and FIG. 7, FIG. 7 is an implementation aspect provided for use by a user after the wearable apparatus 300 in FIG. 6 and the electronic apparatus 200 in FIG. 3 are combined. In this embodiment, when the electronic apparatus 200 is disposed in the accommodation space of the wearable apparatus 300, and when the cover body 303 is cover the first opening (the first opening is covered by the cover body 303 in FIG. 6, the configuration of the first opening can be referred to the first opening 110 in FIG. 1 or FIG. 2 can be referred to) of the wearable apparatus 300, the optical detector 201 of the electronic apparatus 200 still detects the space information in front of the first side 210 of the electronic apparatus 200 by the through hole 304, and then transmit the space information to the processor 203 shown in FIG. 3. The processor 203 operates the space information by making use of a SLAM algorithm, so as to generate augmented reality scene information and display the augmented reality scene information on the surface of the display screen 202. The augmented reality scene information includes at least one virtual object. A space coordinate is assigned to the virtual object, so that the virtual object is presented at the space coordinate that is assigned to the virtual object.

Likewise, in this embodiment, the upper half part 301 of the wearable apparatus 300 includes the cover body 303 configured to cover the first opening of the upper half part 301. However, in other embodiments, the upper half part 301 of the wearable apparatus 300 does not include the cover body 303, and can use another fixed element to prevent the electronic apparatus 200 from separating from the wearable apparatus 100 during usage.

In this embodiment, when the two eyes of the user are at the second side 320 of the lower half part 302 of the wearable apparatus 300, the surface of the display screen 202 displays the augmented reality scene information, and the display screen 202 further projects an optical signal corresponding to the augmented reality scene information to a direction of the second side 220 of the electronic apparatus 200. As shown in FIG. 7, interaction between the electronic apparatus 200 and the left eye LE of the user is used as an example. The display screen 202 of the electronic apparatus 200 projects the optical signal corresponding to the augmented reality scene information to the direction of the second side 220 of the electronic apparatus 200. The optical signal is transmitted along an optical path P2 from the display screen 202. Then, the optical signal is transmitted to a reflection mirror RM disposed in the upper half part 301, and the optical signal is reflected by the reflection mirror RM. After that, the optical signal is transmitted to an optical lens 305 along the optical path P2, and the optical signal is reflected by the optical lens 305. Then, the optical signal is projected along a reflected optical path P2 to a plane to be imaged on the plane. In an embodiment, the optical signal is transmitted to an observing plane OP of the left eye LE of the user. In this embodiment, the observing plane OP is a retina of the left eye of the user. In this way, an augmented reality scene is imaged on the retina of the left eye of the user, so that the left eye of the user sees the augmented reality scene. Ambient light from the first side 310 of the wearable apparatus 300 partially passes through the optical lens 305 with a transparency factor along an optical path P3 to be transmitted to the observing plane OP of the left eye LE of the user. Therefore, the user can watch part of an ambient scene corresponding to the space information detected by the optical detector 201.

In this embodiment, after an optical signal corresponding to the augmented reality scene information of the right eye of the user is emitted from the display screen 202 and reflected by the reflection mirror RM and the optical lens 305, the augmented reality scene information corresponding to the optical signal is displayed on an retina of the right eye of the user. When the augmented reality scene information is imaged on the retinas of the left and right eyes of the user, the virtual object seems to attach to a physical object in the space information in a proper angle or direction, or interact with a physical object.

In this embodiment, the electronic apparatus 200 is disposed higher than the two eyes of the user, so that the processor 203 of the electronic apparatus 200 controls the display screen 202 to project the optical signal corresponding to the augmented reality scene information after correcting the virtual object in the augmented reality scene information. In an embodiment, the processor 203 first corrects the augmented reality scene information according to a relative distance and a relative angle between the optical detector 201 and the two eyes of the user, so that the augmented reality scene information is displayed in a right shape and size corresponding to a real viewing angle of the user. Then, the processor 203 controls the display screen 202, so that other parts of the display screen 202 without displaying the virtual object in the augmented reality scene information are nonluminous. Subsequently, the processor 203 corrects the shape and the size of the virtual object according to configuration angles of the reflection mirror RM and the optical lens 305. Finally, the processor 203 projects only an optical signal corresponding to the virtual object of the augmented reality scene information. The optical signal enters the two eyes of the user after being reflected by the reflection mirror RM and the optical lens 305, so that the user watches the virtual object in the augmented reality scene information.

In one embodiment, the ambient light from the front of the first side 310 of the wearable apparatus 300 passes through the optical lens 305 to be transmitted to the observing plane OP along the optical path P3, so that the user can watch part of the ambient scene corresponding to the space information detected by the optical detector 201. In this embodiment, the user simultaneously watches an external ambient scene and the virtual object in the augmented reality scene information by the optical lens 305, and the shape and the size displayed by the virtual object also correspond to the real viewing angle of the user.

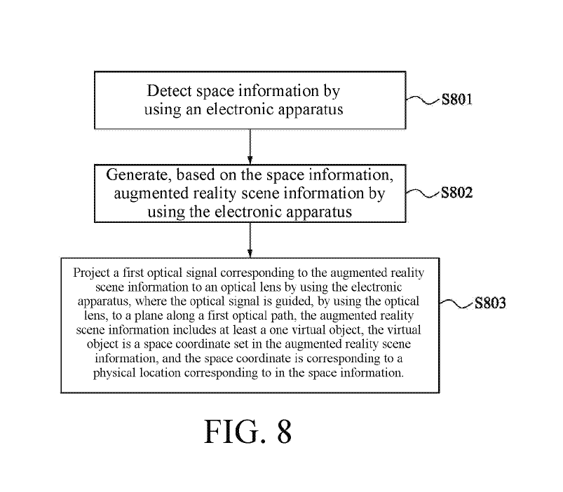

Referring to FIG. 8, FIG. 8 is a flowchart of steps of an augmented reality method according to some embodiments of this application. In this embodiment, for an augmented reality system used by the augmented reality method, refer to the embodiments in FIG. 1 to FIG. 7 together in this application. In this embodiment, steps included in the augmented reality method are described in detail in the following paragraphs.

Step S801: Detect space information by an electronic apparatus. As shown in FIG. 1 to FIG. 5, in this embodiment, the electronic apparatus 200 includes the optical detector 201. When the electronic apparatus 200 is disposed in the wearable apparatus 100, the optical detector 201 detects the space information outside the first side 210 of the electronic apparatus 200 by the through hole 104. As shown in FIG. 3, FIG. 6, and FIG. 7, in this embodiment, when the electronic apparatus 200 is disposed in the wearable apparatus 300, the optical detector 201 detects the space information outside the first side 210 of the electronic apparatus 200 by the through hole 304. When the optical detector 201 obtains the space information outside the first side 210, the space information is transmitted to the processor 203 that is electrically coupled to the optical detector 201.

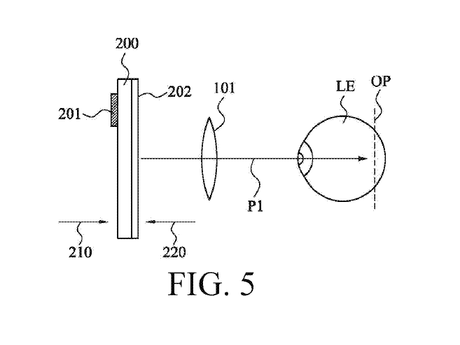

Step S802: Generate the augmented reality scene information by the electronic apparatus based on the space information. As shown in FIG. 3, FIG. 5, and FIG. 7, in the foregoing embodiments, after receiving the space information from the optical detector 201, the electronic apparatus 200 operates the space information by SLAM algorithm, so as to generate the augmented reality scene information. Then the processor 203 displays the augmented reality scene information on the surface of the display screen 202.

Step S803: Project a first optical signal corresponding to the augmented reality scene information to an optical lens by the electronic apparatus, where the optical signal is transmitted to an observing plane through the optical lens. In an embodiment, the augmented reality scene information includes at least one virtual object. And, the virtual object is disposed at a space coordinate of in the augmented reality scene information, and the space coordinate is corresponding to a physical location in the space information.

For step S803, such as the embodiments shown in FIG. 3 and FIG. 5, in the foregoing embodiments, when the left eye LE of the user wears the wearable apparatus 100, the display screen 202 displays the augmented reality scene information, and the display screen 202 further projects the optical signal corresponding to the augmented reality scene information to the direction of the second side 220 of the electronic apparatus 200. The optical signal is transmitted along the optical path P1 from the display screen 202. The optical signal passes through the first optical lens 101 to be transmitted to the observing plane OP of the left eye LE of the user. In the embodiments, the observing plane OP is the retina of the left eye of the user. Therefore, the user sees the augmented reality scene information displayed on the display screen 202.

For step S803, such as the embodiments shown in FIG. 3 and FIG. 7, in the foregoing embodiments, when user wears the wearable apparatus 100, the display screen 202 displays only the virtual object of the augmented reality scene information, and the display screen 202 further projects the optical signal corresponding to the augmented reality scene information to the direction of the second side 220 of the electronic apparatus 200. As shown in FIG. 7, the optical signal is transmitted along the optical path P2 from the display screen 202. The optical signal is transmitted to the reflection mirror RM disposed in the upper half part 301, and the optical signal is reflected by the reflection mirror RM. Then, he optical signal is transmitted to the optical lens 305 along the optical path P2. Finally, the optical signal is transmitted to the observing plane OP of the left eye LE of the user. In addition, the ambient light from the front of the wearable apparatus 300 passes through the optical lens 305 with a transparency factor along the optical path P3 to be transmitted to the observing plane OP of the left eye LE of the user, so that the user watches part of the ambient scene corresponding to the space information detected by the optical detector 201.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. An augmented reality system, comprising:
a wearable apparatus, having an optical lens and a connection unit; and
an electronic apparatus, disposed on the wearable apparatus by the connection unit, and the electronic apparatus is configured to detect space information and generate augmented reality scene information according to the space information, and project an optical signal corresponding to the augmented reality scene information to the optical lens, wherein the optical signal is guided to a plane along a first optical path by using the optical lens; wherein the augmented reality scene information comprises at least one virtual object, the virtual object is disposed at a space coordinate in the augmented reality scene information, and the space coordinate is corresponding to a physical location in the space information.

2. The augmented reality system according to claim 1, wherein the electronic apparatus comprises:
an optical detector, disposed on a first side of the electronic apparatus and configured to detect the space information;
a display screen with an imaging surface, disposed on a second side of the electronic apparatus; and
a processor, configured to display the augmented reality scene information on the imaging surface according to the space information, and project the optical signal to the optical lens by the display screen.

3. The augmented reality system according to claim 1, wherein the first optical path is guided to the plane through the optical lens.

4. The augmented reality system according to claim 1, wherein the first optical path is guided to the optical lens by a reflection lens and then reflected to the plane by the optical lens.

5. The augmented reality system according to claim 4, wherein the optical lens is further configured to guide ambient light to the plane along a second optical path.

6. The augmented reality system according to claim 4, wherein the electronic apparatus displays only the virtual object of the augmented reality scene information.

7. The augmented reality system according to claim 1, wherein the electronic apparatus is further configured to correct the shape and the size of the virtual object according to a relative distance and a relative angle between the electronic apparatus and the plane.

8. A method for providing augmented reality, comprising:
detecting space information by an electronic apparatus;
generating augmented reality scene information by the electronic apparatus based on the space information; and
projecting a first optical signal corresponding to the augmented reality scene information to an optical lens by the electronic apparatus, wherein the optical signal is guided to a plane along a first optical path by the optical lens, the augmented reality scene information comprises at least one virtual object, the virtual object is disposed at a space coordinate in the augmented reality scene information, and the space coordinate is corresponding to a physical location in the space information.

9. The method for providing augmented reality according to claim 8, wherein the first optical path is guided to the optical lens by a reflection lens and then reflected to the plane by using the optical lens.

10. The method for providing augmented reality according to claim 8, wherein the electronic apparatus displays only the virtual object in the augmented reality scene information.
